(19) United States
(12) Patent Application Publication
(10) Pub. No.: US 2004/0144435 A1
(43) Pub. Date: Jul. 29, 2004

(54) Check valve

(76) Inventor: Richard C.G. Dark, Fallbrook, CA (US)

Correspondence Address: LAW OFFICES OF ERIC KARICH, 2807 ST. MARK DR., MANSFIELD, TX, 76063, US

(21) Appl. No.: 10/350,548

(22) Filed: Jan. 23, 2003

(51) Int. Cl. F16K 15/14

(52) U.S. Cl. 137/844

(57) ABSTRACT

A check valve has a resilient diaphragm that has top and bottom surfaces that terminate in a perimeter. A curved slit is cut through both the top and bottom surfaces. A flex line is formed between the ends of the curved slit, the curved slit and the flex line together defining a valve actuation area. The curved slit is cut at an angle to form a valve seat surface under the valve actuation area, and to form a diaphragm seat surface adjacent the valve actuation area. The valve actuation area is able to flex, generally along the flex line, from a sealed position wherein the valve seat surface contacts the diaphragm seat surface and seals the check valve, to a flow position wherein valve seat surface and the diaphragm seat surface are exposed and the curved slit allows flow through the check valve.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to check valves, and more particularly to a check valve that includes a resilient diaphragm having a curved slit that is cut at an angle to a top surface of the curved slit.

2. Description of Related Art

Various self-closing dispensing valves and closures have been designed to fit onto containers for dispensing beverages, liquids, soaps, lotions, and other fluent materials. The closures may also be used on baby drinking cups or cyclist water bottles whereupon the beverage would be dispensed by sucking on the closure or by squeezing the container.

Check valves that include resilient diaphragms that have been slit to allow fluid flow are known in the art. Examples of these constructions are taught in Brown, U.S. Pat. No. 6,427,874 and U.S. Pat. No. 6,279,783; Rohr, U.S. Pat. No. 5,005,737 and U.S. Pat. No. 5,271,531; and other related patents assigned to Seaquist Closures, a division of Pittway Corporation, of Mukwonago, Wis.) (“the Seaquist patents”). The Seaquist patents teach the use of a silicone dome dispensing system whereby the dome is penetrated by a pair of slits. The slits on the prior art domed surfaces open like petals when sufficient force is pushed upon it by the difference in the pressure in the container as compared to the pressure outside the container. These slits are cut at an angle that is approximately normal to the top surface of the dome. While the slits illustrated in the above-described patents are functional, the slits are not effective in preventing accidental leakage if the container is bumped or dropped. Furthermore, the domed construction does not provide for venting air back into the container.

Another prior art dispensing closure is shown in Imbery, Jr., U.S. Pat. No. 5,169,035. The Imbery, Jr. valve is excellent at venting air back into the container without allowing leakage through the venting flow path; however, the Imbery, Jr. closure does not teach a mechanism to control the outward flow of the fluid through the primary conduit.

The above-described references are hereby incorporated by reference in full.

The prior art teaches various check valves. However, the prior art does not teach a check valve that includes a resilient diaphragm having a curved slit that is cut at an angle to a top surface of the curved slit. This structure allows for the one-way flow of fluids of various viscosities using a check valve that is inexpensive to manufacture, easy to use, and easy to customize to provide specific flow characteristics The present invention fulfills these needs and provides further related advantages as described in the following summary.

### SUMMARY OF THE INVENTION

The present invention teaches certain benefits in construction and use which give rise to the objectives described below.

The present invention provides a check valve having a resilient diaphragm that has a top surface and a bottom surface. The top and bottom surfaces terminate in a perimeter. A curved slit is cut through both the top and bottom surfaces and includes two ends. A flex line is formed between the ends of the curved slit, the curved slit and the flex line together defining a valve actuation area. The curved slit is cut at an angle to form a valve seat surface and a diaphragm seat surface. The valve seat surface is formed under the valve actuation area adjacent the bottom surface. The diaphragm seat surface is formed adjacent the valve actuation area and shaped to contact and seal against the valve seat surface. The valve actuation area is able to flex, generally along the flex line, from a sealed position wherein the valve seat surface contacts the diaphragm seat surface and seals the check valve, to a flow position wherein valve seat surface and the diaphragm seat surface are exposed and the curved slit allows flow through the check valve.

A primary objective of the present invention is to provide a check valve having advantages not taught by the prior art.

Another objective is to provide a check valve that does not require a mold and is extremely inexpensive to manufacture, typically requiring only a disk of resilient material and a single cutting procedure.

A further objective is to provide a check valve that can be readily closed to prevent leakage, but can also quickly open to accommodate high volume flow rates of fluids of almost any viscosity.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of a first embodiment of a resilient diaphragm, the resilient diaphragm having a curved slit in a sealed position;

FIG. 2 is a perspective view thereof illustrating the curved slit in a flow position;

FIG. 3 is a sectional view taken along line 3-3 in FIG. 1;

FIG. 4 is a sectional view taken along line 4-4 in FIG. 2;

FIG. 5 is a perspective view of a second embodiment of the resilient diaphragm, the resilient diaphragm having the curved slit in the flow position, and also including a venting curved slit illustrated in a sealed position;

FIG. 6 is a perspective view thereof illustrating the curved slit in the sealed position and the venting curved slit in a venting position;

FIG. 7 is a sectional view taken along line 7-7 in FIG. 5;

FIG. 8 is a sectional view taken along line 8-8 in FIG. 6;

FIG. 9 is a perspective view of a cap assembly that includes the second embodiment of the resilient diaphragm, the curved slit being shown in the flow position and the venting curved slit being shown in the sealed position;

FIG. 10 is a perspective view thereof, the curved slit being shown in the sealed position and the venting curved slit being shown in the venting position;

FIG. 11 is a perspective view thereof illustrating a cover plate positioned over the resilient diaphragm of the cap assembly;

FIG. 12 is a sectional view taken along line 12-12 in FIG. 11, further illustrating a container upon which the cap assembly has been threadedly engaged;

FIG. 13 is an exploded perspective view of the cap assembly;

FIG. 14 is a perspective view of a third embodiment of the resilient diaphragm, wherein the resilient diaphragm includes a nipple and a mounting flange;

FIG. 15 is a sectional view taken along line 15-15 in FIG. 14, further illustrating a mounting ring that is used to mount the resilient diaphragm upon a baby bottle, the curved slit being illustrated in a sealed position; and

FIG. 16 is a sectional view similar to FIG. 15, illustrating the curved slit in a venting position.

### DETAILED DESCRIPTION OF THE INVENTION

The above-described drawing figures illustrate the invention, a check valve 10 for closing a conduit such as a container 66. The check valve 10 includes a resilient diaphragm 20 that includes a top surface 22 and a bottom surface 24. Critical to the invention, the resilient diaphragm 20 includes a curved slit 28 that is cut at an angle through both the top and bottom surfaces 22 and 24.

First Embodiment

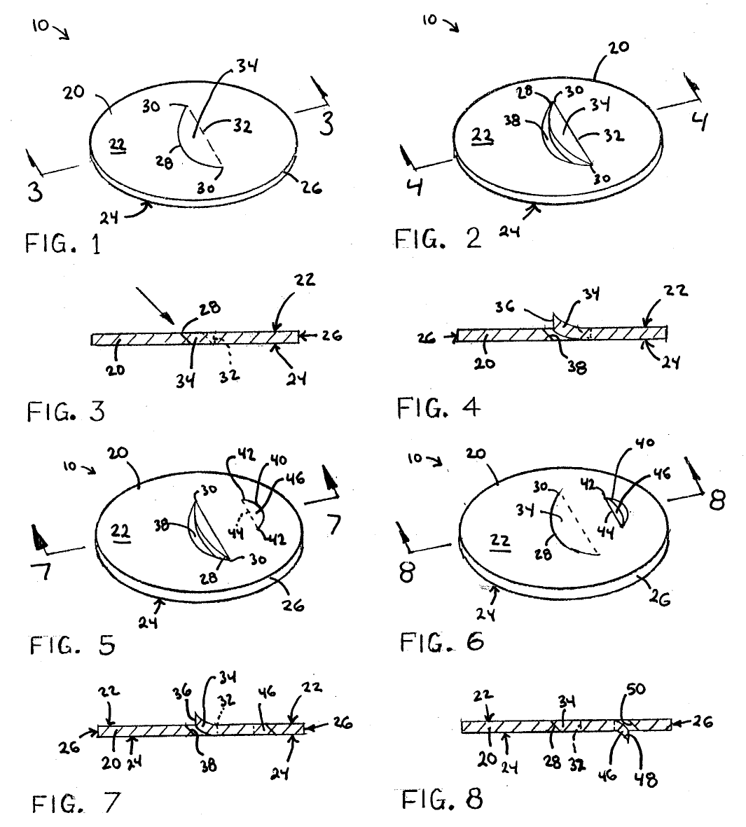

In a first embodiment, as shown in FIGS. 1-4, the top and bottom surfaces 22 and 24 of the resilient diaphragm 20 terminate in a perimeter 26. In the simplest embodiment, the resilient diaphragm 20 is a sheet of rubber, plastic, or similar resilient material, preferably cut in a shape to match the cross-section of the conduit. In the present embodiment, the resilient diaphragm 20 is shaped like a disk and is made of rubber, and the top and bottom surfaces 22 and 24 are substantially planar. The curved slit 28 is generally crescent shaped and has two ends 30 which, together, form a flex line 32 therebetween. The curved slit 28 and the flex line 32 together defining a valve actuation area 34.

It is critical that the curved slit 28 is cut at an angle with respect to the top and bottom surfaces 22 and 24 to form a valve seat surface 36 and a diaphragm seat surface 38. The curved slit 28 may be cut at any angle other than normal to the top surface 22; and the cutting angle is preferably between 35-55 degrees, most preferably approximately 45 degrees, forming the valve seat surface 36 under the valve actuation area 34 adjacent the bottom surface 24. The diaphragm seat surface 38 is adjacent the valve actuation area 34 and shaped to contact and seal against the valve seat surface 36. By cutting the curved slit 28 at an angle, the curved slit 28 can open only in one direction, and only when the curved slit 28 is placed under enough pressure to overcome the resilience of the resilient diaphragm 20. By making the resilient diaphragm 20 thicker or of a stiffer material, the amount of pressure required to open the curved slit 28 can be increased (or, inversely, decreased).

The terms top surface 22 and bottom surface 24 are hereby defined to refer to the surfaces of the resilient diaphragm 20 oriented with respect to the direction of fluid flow through the check valve 10. For example, in FIGS. 1-4, the top surface 22 is shown on top because fluid flows from below the valve shown towards the top surface 22. The terms are used interchangeably, however, and this becomes inverted with respect to the venting curved slit 40, shown in FIGS. 5-8. In FIGS. 14-16, the top surface 22 is actually shown in the underside of the nipple 76, because the fluid flow is reversed as the check valve 10 is used for venting in this instance, and there is only a flow slit 80 for fluid to flow out of the container 66.

As shown in FIG. 3, the curved slit 28 is initially in a sealed position wherein the valve seat surface 36 contacts the diaphragm seat surface 38 and seals the check valve 10. The shape and angled cut of the curved slit 28 function to maintain the curved slit 28 in the sealed position despite pressure against the top surface 22. The amount of resistance that the check valve 10 has to opening can also be modified by modifying the size and shape of the curved slit 28. Obviously, if the curved slit 28 is longer, and/or has a sharper curve, the curved slit will open more easily and dispense more fluid. Such modifications can be made by those skilled in the art to suit the fluid flowing through the check valve 10.

Once a larger amount of pressure is exerted against the bottom surface 24, the valve actuation area 34 is able to flex, generally along the flex line 32, from the sealed position to a flow position, as shown in FIG. 4. In the flow position, the valve seat surface 36 lifts off of the diaphragm seat surface 38 to allow the fluid to flow through the check valve 10. Due to the angled cut of the curved slit 28, fluid is able to flow in only one direction, in this case from adjacent the bottom surface 24 to adjacent the top surface 22. Obviously, if the cut were inverted, as is described below, fluid would flow in the other direction.

For purposes of this application, the term curved slit 28 is hereby defined to include not only the crescent shape shown, but also a variety of curved shapes, and also functionally equivalent or similar shapes. For example, two straight cuts that intersect each other at an angle function to form the valve actuation area 34, and should therefore be construed to be within the scope of the term curved slit 28. Furthermore, a wavy curve, or an angled open-polygon-shaped cut could also be used. The specific shape of the cut, and whether it is curved or angled, is not important, as long as the valve actuation area 34 is formed and this functional shape is maintained.

The check valve 10 described can be adapted to be used in a wide variety of applications.

For example, the check valve 10 can be mounted within a pipe or similar structure to control fluid flow therethrough. The check valve 10 can also be mounted over a container 66, as described below. Furthermore, if two of the above-described check valves 10 were to be operably connected to a closed container (not shown), with the valves 10 being oriented in opposite directions (one in, one out), the closed container would function as a pump by squeezing the closed container repeatedly. The specific application is not important, as long as the fundamental structure of the curved slit 28 is utilized, with the angled cut under the valve actuation area 34. Alternative embodiments should be considered within the scope of the invention as claimed.

Second Embodiment

As shown in FIGS. 5-8, in a second embodiment the resilient diaphragm 20, described above, further includes a venting curved slit 40 for allowing venting, or flow in the opposite direction as the curved slit 28 described above. The venting curved slit 40 is also cut at an angle through both the top and bottom surfaces 22 and 24, and has two ends 42, similar to the curved slit 28 described above. A venting flex line 44 is formed between the two ends 42 of the venting curved slit 40, and the venting curved slit 40 and the venting flex line 44 together define a venting valve actuation area 46. The venting curved slit 40 is cut at an angle to form a venting valve seat surface 48 and a venting diaphragm seat surface 50.

The primary difference between the curved slit 28 and the venting curved slit 40 is that angle of the cut is in the opposite direction. In the venting curved slit 40, the venting valve seat surface 48 is formed under the venting valve actuation area 46 adjacent the top surface 22, rather than adjacent the bottom surface 24. A venting diaphragm seat surface 50 is formed adjacent the venting valve actuation area 46 and shaped to contact and seal against the venting valve seat surface 48. As with the valve actuation area 34, the venting valve actuation area 46 is able to flex, generally along the venting flex line 44, from a sealed position wherein the venting valve seat surface 48 contacts the venting diaphragm seat surface 50 and seals the check valve 10, to a venting position wherein venting valve seat surface 48 and the venting diaphragm seat surface 50 are exposed and the venting curved slit 40 allows venting through the check valve 10. The second embodiment allows controlled fluid flow in two directions, generally enabling the fluid (not shown) to flow out through the curved slit 28 when it is forced out, and then allow air to vent back through the venting curved slit 40.

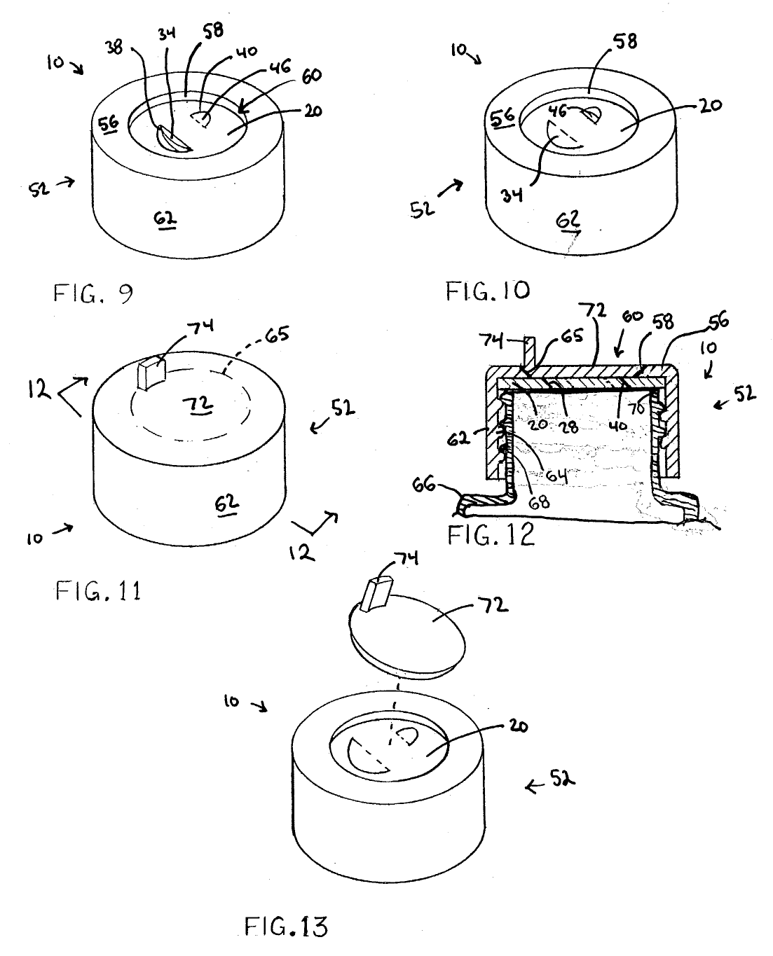

The check valve 10 typically includes a means for mounting the resilient diaphragm 20 across the conduit such that flow cannot occur between the perimeter 26 of the resilient diaphragm 20 and the conduit. As shown in FIGS. 9-13, in one embodiment the means for mounting includes a cap assembly 52 that includes a cap 54 having an inwardly extending flange 56 and a downwardly extending sidewall 62. The downwardly extending sidewall 62 may be generally cylindrical in shape (although other shapes are possible) and generally is adapted to engage the container 66. In some embodiments, the downwardly extending sidewall 62 can form at least a part of the conduit as well.

As shown in FIGS. 9-13, the inwardly extending flange 56 has an inner perimeter 58 that defines a flow aperture 60. In this embodiment, as shown in FIGS. 9, 10, and 12, the resilient diaphragm 20 is shaped to sit within the downwardly extending sidewall 62 against the inwardly extending flange 56, operably positioning resilient diaphragm 20 to cover the flow aperture 60 such that the curved slit 28 and the venting curved slit 40 are positioned to allow flow through the flow aperture 60.

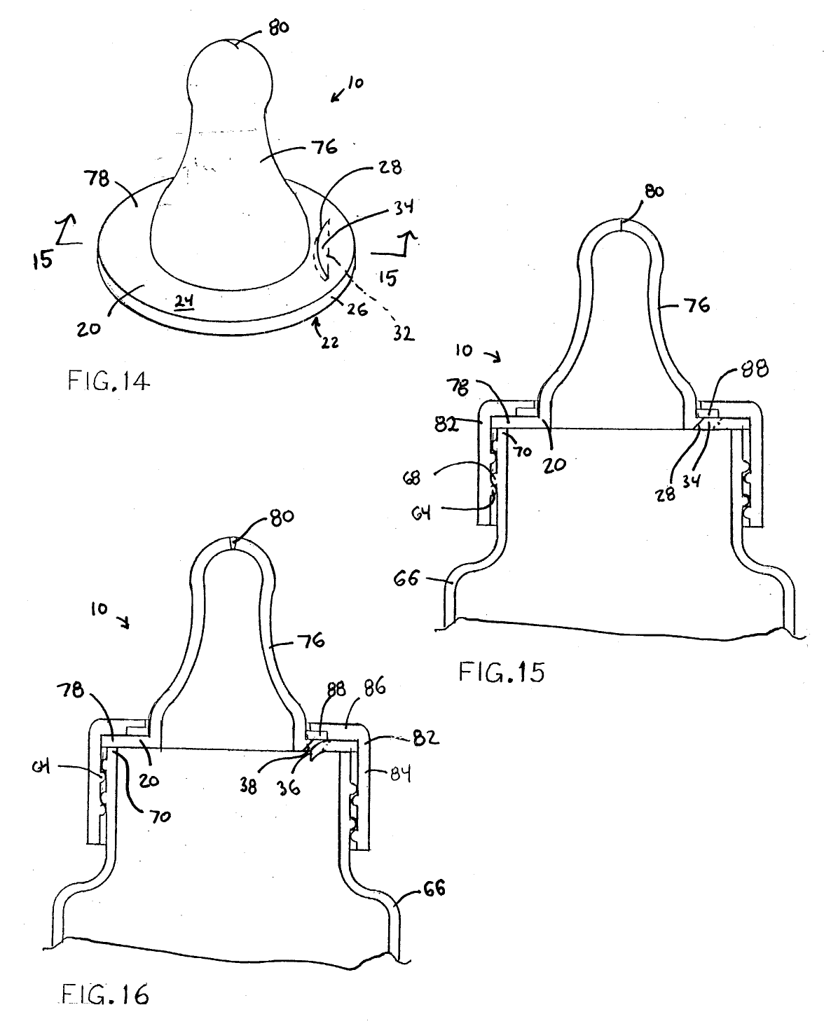

As shown in FIG. 12, the downwardly extending sidewall 62 may include an inner threaded surface 64 that is adapted to threadedly engage an outer threaded surface 68 of the container 66. The perimeter 26 of the resilient diaphragm 20 may abut the inner threaded surface 64 to improve the quality of the seal formed therebetween. A lip 70 of the container 66 preferably compresses the resilient diaphragm 20 against the inwardly extending flange 56, thereby forming a good seal. In this manner, the resilient diaphragm 20 functions as a liner such as is commonly used in similar prior art caps.

In this embodiment, the cap assembly 52 preferably includes a cover plate 72 that is initially attached to the inner perimeter 58 of the inwardly extending flange. The cover plate 72 functions to protect the resilient diaphragm 20 and to hold the curved slit 28 in the sealed position. The cover plate 72 is preferably attached to the inner perimeter 58 with a weakened portion 65, or a tearable webbing (not shown), that allows the cover plate 72 to be torn off the inner perimeter 58. The cover plate 72 may include a tab 74 or similar handle or graspable portion that enables the user to easily grasp the cover plate 72 and tear it off of the inner perimeter 58. In an alternative embodiment (not shown), the tab 74 is removably attached to the container so that it is possible to remove the tab 74 for use, and then replace the tab 74 and thereby reseal the container 66.

In operation, the cap assembly 52 including the check valve 10 can be placed on the container 66, such as a bottle of shampoo or similar fluid. As long as the tab 74 is in place, the check valve 10 is held in the sealed position and the container 66 will not leak. When ready for use, the tab 74 is removed. Even with the tab 74 removed, the container 66 will not generally leak if it is inadvertently inverted or knocked over, due to the natural resistance of the resilient diaphragm 20. A gentle squeeze of the container 66, however, will force the valve actuation area 34 to move from the sealed position to the flow position, as described above, thereby dispensing the shampoo or other fluid. Depending upon the thickness and resilience of the resilient diaphragm 20, the shape of the curved slit 28, and the area of the valve actuation area 34, it is possible to have either very large or very small flow rates of the fluid, regardless of the viscosity of the fluid.

When the pressure on the container 66 is released, the curved slit 28 returns to the sealed position, and the inward pressure pulls the venting valve actuation area 46 from the sealed position to the venting position. In this position, air can vent back into the container 66 through the venting curved slit 40. Once the container 66 has vented, the venting valve actuation area 46 returns to the sealed position.

Third Embodiment

In a third embodiment, as shown in FIGS. 14-16, the resilient diaphragm 20 is shaped to form a nipple 76 surrounded by a mounting flange 78. The nipple 76 may have a flow slit 80 such as is commonly used in prior art baby bottle nipples, or any other aperture that enables fluid to flow out of the container 66. In this embodiment, the container 66 is a baby bottle, and the curved slit 28 is cut through the mounting flange 78 to allow venting through the resilient diaphragm 20.

In this embodiment, the means for mounting is a mounting ring 82 that includes a sidewall 84 and a nipple receiving flange 86 that is very similar to the cap 54 described above. The nipple receiving flange 86 is shaped to receive the nipple 76 and engage the mounting flange 78. The nipple receiving flange 86 includes a flow channel 88 that allows air to vent through the curved slit 28 without being impeded by the mounting flange 78.

In use, both the flow slit 80 of the nipple 76 and the venting curved slit 40 are initially closed, as shown in FIG. 15. When suction is applied to the nipple 76, as when a baby sucks on the nipple 76, the flow slit 80 opens to allow fluid to flow to the baby. The loss of fluid lowers the pressure within the container 66, and this lower pressure opens the curved slit 28, thereby allowing air to flow through the flow channel 88, through the curved slit 28, and into the container 66, thereby raising the pressure and allowing the baby to continue feeding without blocked or reduced fluid flow.

The invention also includes a method for regulating the flow of a fluid through a conduit using the check valve 10 described above. The check valve 10 is mounted across the conduit such as the container 66 described above such that flow cannot occur between the perimeter 26 and the conduit. Then, the fluid is forced against the bottom surface 24 of the resilient diaphragm 20, thereby causing the valve actuation area 34 to flex, generally along the flex line 32, from the sealed position to the flow position, as described above. The fluid can be forced in many ways, including pressurizing the fluid, as with squeezing the container 66, or by lowering the pressure outside the container 66, such as by sucking on the nipple 76 described above, or by sucking on another form of container 66 such as a sports bottle.

While the invention has been described with reference to at least one preferred embodiment, it is to be clearly understood by those skilled in the art that the invention is not limited thereto. Rather, the scope of the invention is to be interpreted only in conjunction with the appended claims.

All patents, patent applications, and other documents and printed matter cited or referred to in this application is hereby incorporated by reference in full.

What is claimed is:

1. A check valve comprising:
a resilient diaphragm having a top surface and a bottom surface, the top and bottom surfaces terminating in a perimeter;
a curved slit cut through both the top and bottom surfaces, the curved slit having two ends; and
a flex line formed between the ends of the curved slit, the curved slit and the flex line together defining a valve actuation area,
the curved slit being cut at an angle other than normal to the top surface to form a valve seat surface and a diaphragm seat surface, the valve seat surface being formed under the valve actuation area, and the diaphragm seat surface being formed adjacent the valve actuation area and shaped to contact and seal against the valve seat surface, and
wherein the valve actuation area is able to flex, generally along the flex line, from a sealed position wherein the valve seat surface contacts the diaphragm seat surface and seals the check valve, to a flow position wherein valve seat surface lifts off the diaphragm seat surface to allow flow in one direction through the check valve.

2. The check valve of claim 1 further comprising a venting curved slit through both the top and bottom surfaces, the venting curved slit having two ends;
a venting flex line formed between the ends of the venting curved slit, the venting curved slit and the venting flex line together defining a venting valve actuation area; and
the venting curved slit being cut at an angle other than normal to the top surface to form a venting valve seat surface and a venting diaphragm seat surface, the venting valve seat surface being formed under the venting valve actuation area, and a venting diaphragm seat surface adjacent the venting valve actuation area and shaped to contact and seal against the venting valve seat surface,
wherein the venting valve actuation area is able to flex, generally along the venting flex line, from a sealed position wherein the venting valve seat surface contacts the venting diaphragm seat surface and seals the check valve, to a venting position wherein venting valve seat surface lifts off of the venting diaphragm seat surface to allow venting through the check valve.

3. The check valve of claim 1 further comprising a means for mounting the resilient diaphragm across a conduit such that flow cannot occur between the perimeter and the conduit.

4. The check valve of claim 1 wherein the resilient diaphragm is shaped to form a nipple surrounded by a mounting flange, the nipple having a flow slit, the curved slit being cut through the mounting flange to allow venting through the resilient diaphragm.

5. The check valve of claim 4 further including a mounting ring that includes a sidewall and a nipple receiving flange, the nipple receiving flange being shaped to receive the nipple and engage the mounting flange, the nipple receiving flange having a flow channel that allows air to vent through the venting curved slit.

6. The check valve of claim 1 further comprising a cap assembly having a cap with an inwardly extending flange and a downwardly extending sidewall, the inwardly extending flange having an inner perimeter that defines a flow aperture.

7. The check valve of claim 6 wherein the downwardly extending sidewall is generally cylindrical.

8. The check valve of claim 1 wherein the curved slit is cut at an angle of between 35-55 degrees from normal to the top surface.

9. The check valve of claim 1 wherein the top and bottom surfaces are substantially planar.

10. A check valve for closing a conduit, the check valve comprising:
a resilient diaphragm having a top surface and a bottom surface, the top and bottom surfaces terminating in a perimeter;
a curved slit through both the top and bottom surfaces, the curved slit having two ends;
a flex line formed between the ends of the curved slit, the curved slit and the flex line together defining a valve actuation area;
the curved slit being cut at an angle to form a valve seat surface and a diaphragm seat surface, the valve seat surface being formed under the valve actuation area, and a diaphragm seat surface adjacent the valve actuation area and shaped to contact and seal against the valve seat surface; and
a means for mounting the resilient diaphragm across the conduit such that flow cannot occur between the perimeter and the conduit,
wherein the valve actuation area is able to flex, generally along the flex line, from a sealed position wherein the valve seat surface contacts the diaphragm seat surface and seals the check valve, to a flow position wherein valve seat surface lifts off the diaphragm seat surface to allow flow in one direction through the check valve.

11. The check valve of claim 10 further comprising a venting curved slit through both the top and bottom surfaces, the venting curved slit having two ends;
a venting flex line formed between the ends of the venting curved slit, the venting curved slit and the venting flex line together defining a venting valve actuation area; and
the venting curved slit being cut at an angle to form a venting valve seat surface and a venting diaphragm seat surface, the venting valve seat surface being formed under the venting valve actuation area, and a venting diaphragm seat surface adjacent the venting valve actuation area and shaped to contact and seal against the venting valve seat surface,
wherein the venting valve actuation area is able to flex, generally along the venting flex line, from a sealed position wherein the venting valve seat surface contacts the venting diaphragm seat surface and seals the check valve, to a venting position wherein venting valve seat surface lifts off of the venting diaphragm seat surface to allow venting through the check valve.

12. The check valve of claim 10 wherein the resilient diaphragm is shaped to form a nipple surrounded by a mounting flange, the nipple having a flow slit, the curved slit being cut through the mounting flange to allow venting through the resilient diaphragm.

13. The check valve of claim 12 wherein the means for mounting includes a mounting ring that has a sidewall and a nipple receiving flange, the nipple receiving flange being shaped to receive the nipple and engage the mounting flange, the nipple receiving flange having a flow channel that allows air to vent through the venting curved slit.

14. The check valve of claim 10 further comprising a cap assembly having a cap with an inwardly extending flange and a downwardly extending sidewall, the inwardly extending flange having an inner perimeter that defines a flow aperture.

15. The check valve of claim 14 wherein the downwardly extending sidewall is generally cylindrical.

16. The check valve of claim 10 wherein the curved slit is cut at an angle of between 35-55 degrees from normal to the top surface.

17. The check valve of claim 10 wherein the top and bottom surfaces are substantially planar.

18. A cap assembly comprising:
a cap having an inwardly extending flange and a downwardly extending sidewall, the inwardly extending flange having an inner perimeter that defines a flow aperture;
a resilient diaphragm having a top surface and a bottom surface, the top and bottom surfaces terminating in a perimeter, the resilient diaphragm being disposed within the cap to cover the flow aperture;
a curved slit cut through both the top and bottom surfaces, the curved slit having two ends;
a flex line formed between the ends of the curved slit, the curved slit and the flex line together defining a valve actuation area; and
the curved slit being cut at an angle to form a valve seat surface and a diaphragm seat surface, the valve seat surface being formed under the valve actuation area, and a diaphragm seat surface adjacent the valve actuation area and shaped to contact and seal against the valve seat surface, and
wherein the valve actuation area is able to flex, generally along the flex line, from a sealed position wherein the valve seat surface contacts the diaphragm seat surface and seals the check valve, to a flow position wherein valve seat surface lifts off the diaphragm seat surface to allow flow in one direction through the check valve.

19. The cap assembly of claim 18 wherein the resilient diaphragm further comprises:
a venting curved slit through both the top and bottom surfaces, the venting curved slit having two ends;
a venting flex line formed between the ends of the venting curved slit, the venting curved slit and the venting flex line together defining a venting valve actuation area; and
the venting curved slit being cut at an angle to form a venting valve seat surface and a venting diaphragm seat surface, the venting valve seat surface being formed under the venting valve actuation area, and a venting diaphragm seat surface adjacent the venting valve actuation area and shaped to contact and seal against the venting valve seat surface,
wherein the venting valve actuation area is able to flex, generally along the venting flex line, from a sealed position wherein the venting valve seat surface contacts the venting diaphragm seat surface and seals the check valve, to a venting position wherein venting valve seat surface lifts off of the venting diaphragm seat surface to allow venting through the check valve.

20. The cap assembly of claim 18 wherein the resilient diaphragm is shaped to form a nipple surrounded by a mounting flange, the nipple having a flow slit and being shaped to fit through the flow aperture of the cap such that the mounting flange contacts the inwardly extending flange, the curved slit being cut through the mounting flange to allow venting through the resilient diaphragm.

21. A method for regulating the flow of a fluid through a conduit, the method comprising the steps of:
a) providing a check valve comprising:
a resilient diaphragm having a top surface and a bottom surface, the top and bottom surfaces terminating in a perimeter;
a curved slit through both the top and bottom surfaces, the curved slit having two ends;
a flex line formed between the ends of the curved slit, the curved slit and the flex line together defining a valve actuation area;
the curved slit being cut at an angle to form a valve seat surface and a diaphragm seat surface, the valve seat surface being formed under the valve actuation area, and a diaphragm seat surface adjacent the valve actuation area and shaped to contact and seal against the valve seat surface; and
b) mounting the check valve across the conduit such that flow cannot occur between the perimeter and the conduit; and
c) forcing a fluid against the bottom surface of the check valve, thereby causing the valve actuation area to flex, generally along the flex line, from a sealed position wherein the valve seat surface contacts the diaphragm seat surface and seals the check valve, to a flow position wherein valve seat surface lifts off of the diaphragm seat surface to allow flow through the check valve.

22. A method for manufacturing a check valve comprising:
a) providing a resilient diaphragm having a top surface and a bottom surface, the top and bottom surfaces terminating in a perimeter; and
b) cutting a curved slit at an angle other than normal to the top surface, through both the top and bottom surfaces, to form a valve actuation area that includes a valve seat surface and a diaphragm seat surface, the valve seat surface being formed beneath the valve actuation area, and the diaphragm seat surface being formed adjacent the valve actuation area, such that the valve actuation area is able to flex between a sealed position wherein the valve seat surface contacts the diaphragm seat surface to seal the resilient diaphragm, and a flow position wherein valve seat surface and the diaphragm seat surface are exposed and the curved slit allows flow through the resilient diaphragm.

23. The method of claim 22 wherein the curved slit is cut at an angle of between 35-55 degrees from normal to the top surface.

24. The check valve of claim 22 wherein the curved slit is cut at an angle of approximately 45 degrees from normal to the top surface.
